(19) United States
(12) Patent Application Publication
(10) Pub. No.: US 2005/0217324 A1
(43) Pub. Date: Oct. 6, 2005

(54) Lock with a linear movement hook resulting from rotatable movement of a control knob

(75) Inventor: Tony Miao, Taipei Hsien (TW)

Correspondence Address: VEDDER PRICE KAUFMAN & KAMMHOLZ, 222 N. LASALLE STREET, CHICAGO, IL, 60601, US

(73) Assignee: Royal Lock Corporation, Wauconda, IL (US)

(21) Appl. No.: 10/820,241

(22) Filed: Apr. 6, 2004

(51) Int. Cl. E05B 65/06

(52) U.S. Cl. 70/134; 70/386

(57) ABSTRACT

An apparatus is provided having a casing to firmly engage a first and second object. The apparatus contains a control knob assembly rotatably connected to the casing. A hooking engagement mechanism is operably connected to the control knob assembly to transform the control knob assembly rotation into lateral movement within the hooking engagement mechanism. The hooking engagement mechanism has a follower member with a hole therethrough. The follower member is capable of engaging the second object. A cam is operably connected to the control knob assembly. Rotation of the control knob assembly results in rotation of the cam. The rotation of the control knob assembly causes the follower member to move linearly so as to attach to and detach from the second object.

### BACKGROUND OF THE INVENTION

1. Field of the Invention

The invention relates generally to an apparatus for securing two objects together by selectively rotating a rotatable knob to activate a hook locking mechanism.

2. Description of Related Art

When referring to a lock with a control knob and a hook driven by the rotatable movement of the control knob, normally the hook is firmly mounted on the control knob so that, when the control knob is rotated, the hook is driven to rotate in a direction the same as that of the control knob. When the hook is rotated, the hook is able to connect to or disconnect from a locking bar to switch between a locked and an unlocked status. In general, a wide variety of different elements may be involved to fixedly mount the hook on the control knob, which complicates the structure of the lock and hence increases the manufacturing cost. Furthermore, the circular displacement of the hook requires a large space to allow the hook to engage and disengage with the locking bar, and that space occupies a large proportion of the room inside the lock body. As a result, the other lock components must be squeezed into the resulting compact space, thus weakening the structural strength of the lock.

As demonstrated above, a need exists for a lock design that does not require the fixed attachment or mounting of a hook to a control knob. Desirably, the space required to allow the hook to engage and disengage with a corresponding locking bar would be relatively small such that the lock components would not need to be squeezed into a compact space.

### BRIEF SUMMARY OF THE INVENTION

An apparatus is provided having a casing to firmly engage a first and second object. The apparatus contains a control knob assembly rotatably connected to the casing. A hooking engagement mechanism is operably connected to the control knob assembly to transform the rotation of the control knob assembly into lateral movement of the hooking engagement mechanism. The hooking engagement mechanism has a follower member with a hole therethrough. The follower member is capable of engaging the second object. A cam is operably connected to the control knob assembly. Rotation of the control knob assembly results in the rotation of the cam. The rotation of the control knob assembly causes the follower member to move linearly and attach and detach with the second object, as required.

### BRIEF DESCRIPTION OF THE SEVERAL VIEWS OF THE DRAWINGS

The invention will be more readily understood with reference to the following drawings, wherein like reference numbers represent like elements and wherein:

FIG. 1 is an exploded perspective view of the lock of one embodiment of the invention;

FIG. 2 is a rear view elevational view of the lock, in an unlocked position, of one embodiment of the invention;

FIG. 3 is a rear perspective view of the lock, in an unlocked position, of one embodiment of the invention;

FIG. 4 is a rear perspective view of the lock, in a locked position, of one embodiment of the invention;

FIG. 5 is a cutaway perspective view of the lock, in a locked position, of one embodiment of the invention;

FIG. 6 is an elevational view of the hooking engagement mechanism, in a locked position, of one embodiment of the invention;

FIG. 7 is an elevational view of the hooking engagement mechanism, in an unlocked position, of one embodiment of the invention;

FIG. 8 is an exploded perspective view of the lock of one embodiment of the invention;

FIG. 9 is a cutaway perspective view of the lock, in a locked position, of one embodiment of the invention;

FIG. 10 is a cutaway perspective view of the lock, in an unlocked position, of one embodiment of the invention;

FIG. 11 is a cutaway elevational view of the lock, in a locked position, of one embodiment of the invention;

FIG. 12 is a cutaway elevational view of the lock, in an operating position, of one embodiment of the invention;

FIG. 13 is an elevational view of the hooking engagement mechanism, in a locked position, of one embodiment of the invention; and

FIG. 14 is an elevational view of the hooking engagement mechanism, in an unlocked position, of one embodiment of the invention.

### DETAILED DESCRIPTION OF THE INVENTION

### FIRST EMBODIMENT

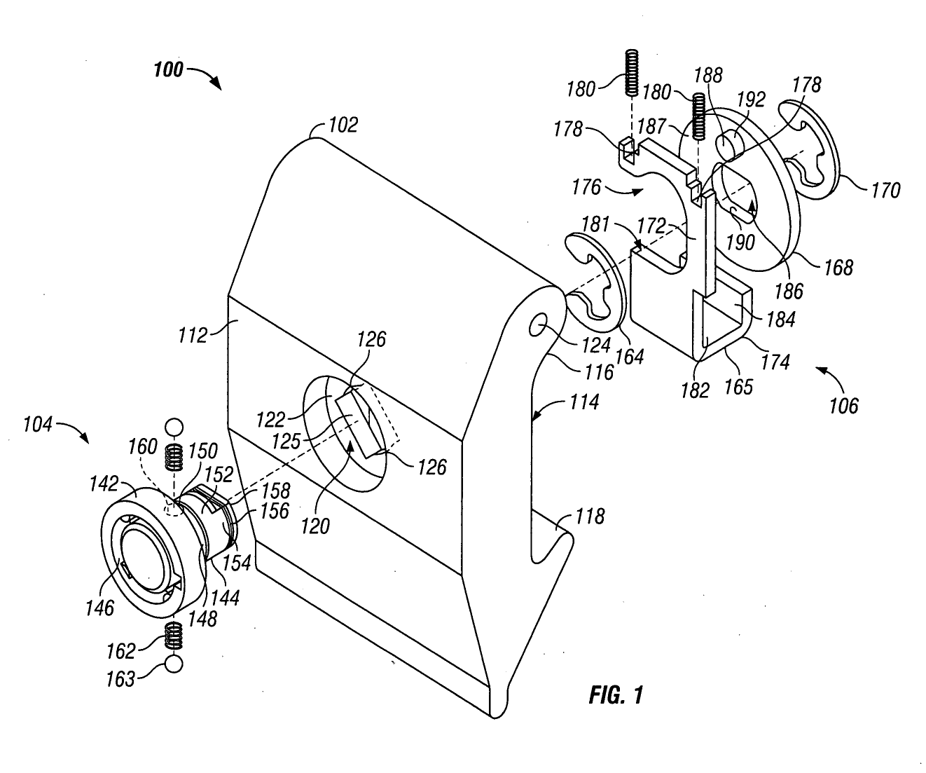

A first embodiment of the invention is shown in FIG. 1 and includes a lock 100 including a casing 102, a control knob assembly 104 and a hooking engagement mechanism 106. The casing 102 further contains a casing face 112, a casing back 114, a first engagement portion 116, a bottom ridge 118, a casing aperture 120, a casing aperture recess 122 and a first engagement portion aperture 124. The casing 102 is preferably, although not exclusively, used in conjunction with a gun case (not shown) such that the casing 102 helps provide a way to secure the top of the gun case to the bottom of a gun case. Here, to secure a top of a gun case to the bottom of a gun case, the casing 102 is hingedly connected to the top of the gun case via a bolt (not shown) or other suitable member rotatably connected to or through the first engagement portion aperture 124 such that the casing 102 can rotate about the first engagement aperture 124. This is particularly useful, as it allows the casing 102 to swing away from a securing appendage, i.e., locking bar, lip, edge, aperture or other structure capable of receiving a portion of the hooking engagement mechanism, located on the bottom of the gun case thus allowing the top and bottom of the gun case to be separated.

The casing face 112 represents the front of the lock 100. The casing back 114 represents the back of the lock 100. The first engagement portion 116, again, is connected to the top of the gun case. In other embodiments, first engagement portion 116 is not hingedly connected to the top of the object, but, rather, simply engages a securing appendage thereon such that, when disengaged, the first engagement portion 116 is free of a connection to the securing appendage of the object.

The first engagement portion 116 provides a way of securing the top of the gun case to the bottom of the gun case via casing 102. The bottom ridge 118 is used to engage a securing appendage located within or extending from the bottom of the gun case such that the top and bottom of the gun case are held together, although not locked. Here the case provides a repelling force when the two sides meet such that then the repelling force is engaged and the top and bottom of the gun case are forced closer together, such that the casing 102 can be rotated past the bottom securing appendage of the gun case such that the bottom ridge 118 engages the underside of the securing appendage when the repelling force is allowed to separate the top and bottom portions of the gun case. Although the above-described embodiment is used in conjunction with securing a top and bottom of a gun case, other embodiments are used to securely engage other objects, including, but not limited to, other hinge-type enclosures such as suitcases and golf cases. Further, another embodiment does not include a repelling force such that the bottom ridge 118 is free to swing away from the case when the lock 100 is in an unlocked position.

The casing aperture 120 in casing 102 allows the control knob assembly 104 to pass therethrough. The casing aperture 120 further includes an inner face 125 and annular recessed areas 126. The inner face 125 defines the casing aperture 120 and is in contact with pre-tensioned ball bearings discussed below in relation to control knob assembly 104. The annular recessed areas 126 are used to receive the pre-tensioned ball bearings therein. The casing aperture recess 122 receives a portion of the control knob assembly 104 therein. Other embodiments do not provide such a recessed area and, therefore, maintain a portion of the control knob assembly 104 above the casing face 112. In addition, other embodiments do not contain annular recessed areas 126 such that the rotation of the control knob assembly 104 does not require a varying force during its rotation.

The control knob assembly 104 includes a control knob head 142 and a neck 144. The control knob head 142 and neck 144 are integrally formed. The control knob assembly 104 is used to operate or drive the hooking engagement mechanism 106 by the clockwise and counterclockwise turning of the assembly. The control knob head 142 contains a key port 146 for receiving a key to open lock 100. Typically, a key is inserted into the key port 146 and the key is then rotated, which in turn rotates the control knob head 142 along with the entire neck 144.

The neck 144 has a rotational axis about which it rotates. The neck 144 also has six portions: a ball bearing section 148, a knob casing securing groove 150, a follower member portion 152, a control plate portion 154, a control plate securing groove 156 and a backstop portion 158. The end of the neck having the backstop portion 158 is the free end of the neck 144. The ball bearing section 148 is an annular ring containing two opposing recesses 160, with corresponding springs 162 and ball bearings 163 (together, a ball-spring combination) located therein. When the control knob assembly 104 is secured within casing 102, the ball bearing section 148 is within the casing aperture 120 of casing 102. When the control knob assembly 104 is rotated, the two sets of corresponding springs 162 and ball bearings 163 engage the inside of the casing aperture 120 of casing 102. When the ball bearings 163 reach the annular recessed areas 126, a larger force is required to move the control knob assembly 104 in either rotatable direction. Accordingly, the ball-spring combination allows for the positioning of the control know assembly 104 into a specific predefined orientation such as an unlocked or a locked position.

The knob casing securing groove 150 is an annular groove having a smaller diameter than the maximum diameter of the neck 144. The follower member portion 152 is an annular ring having a diameter equal to the maximum diameter of neck 144. The control plate portion 154 is an annular ring having a general diameter equal to the maximum diameter of neck 144 and further contains a notched portion therefrom on opposite sides of the neck 144. The control plate securing groove 156 is an annular groove having a smaller diameter than the maximum diameter of the neck 144. Finally, backstop portion 158 is an annular ring having a general diameter equal to the maximum diameter of neck 144 and further contains a notched portion therefrom on opposite sides of the neck 144 in a location corresponding to the notched portions of the control plate portion 154.

The hooking engagement mechanism 106 includes a first C-shaped clamp 164 (bushing), a follower member assembly 165, a control plate 168 and a second C-shaped clamp 170 (bushing). The first C-shaped clamp 164 corresponds to, and when assembled is engaged with, the knob casing securing groove 150 of neck 144 such that the control knob assembly 104 is securely attached to the casing 102 where the control knob assembly 104 is free to rotate with respect to casing 102, but is otherwise restricted in movement with respect to the casing 102. Another embodiment omits the use of the first C-shaped clamp 164 and utilizes the second C-shaped clamp 170 for performing the functions of the first C-shaped clamp 164. In such an embodiment, the casing back 114 provides the sole opposing force to C-shaped clamp 170 to maintain contact between control plate 168 and follower member assembly 165.

The follower member assembly 165 includes a follower member 172 and a hook 174. The follower member 172 further includes a follower member aperture 176, a pair of positioning recesses 178 and two springs 180. The follower member aperture 176 has a follower aperture surface 181 defining the shape thereof. A portion of the follower aperture surface 181 is designed to abut or receive a cam such that movement of the cam along the follower aperture surface 181 causes or drives the linear movement of the follower member assembly 165 with respect to the casing 102. The springs 180 in the positioning recesses 178, located on the top face of the follower member assembly opposite the hook 174, provide a downward force upon the follower member assembly 165 urging it towards an unlocked position. In the unlocked position the springs 180 are in a compressed state, and when in the locked position, are in a decompressed state. The hook 174 has a bottom portion 182 and a lip 184. In the unlocked position the hook 174 rests below the bottom ridge 118 of the casing 102. In the locked position the hook 174, including lip 184 is located above the bottom ridge 118. In the locked position, the raised location of the lip 184 above the bottom ridge 118 prevents the disengagement of the securing appendage on the bottom of the gun case from the lock 100.

The control plate 168 contains a control plate aperture 186, a control plate contact surface 187 and a cam 188 (boss). The control plate aperture 186 has a shape complementary to that of the control plate portion 154 of the neck 144, namely, the control plate aperture 186 is substantially circular with corresponding filled-in portions defined by opposing flat surfaces 190. When the hooking engagement mechanism 106 is assembled about neck 144, the control plate aperture 186 is mated to the control plate portion 154 of the neck 144 such that the neck 144 and the control plate 168 are rotatably attached. Here, the control plate 168 is immovable with respect to neck 144, and vice versa. The cam 188 protrudes from the control plate contact surface 187 and has a cam surface 192. The cam surface 192 does not form a circle with respect to the rotational axis of the neck 144 (and with respect to the rotational axis of cam 188) such that rotation of the cam about the rotational axis of the neck 144 results in the oscillation of the cam surface with respect to a fixed radius about such rotation. In other words, the cam surface 192 does not form a perfect circle about the rotational axis of the neck 144. Therefore, a body in contact with the cam surface 192, as the cam surface 192 rotates, experiences linear movement with respect to the rotational axis of the neck 144. Where, as here, the cam 188 is fixedly attached to the neck 144 at a location having a fixed radius from the neck 144, the rotational axis of the cam 188 and the neck 144 are one and the same.

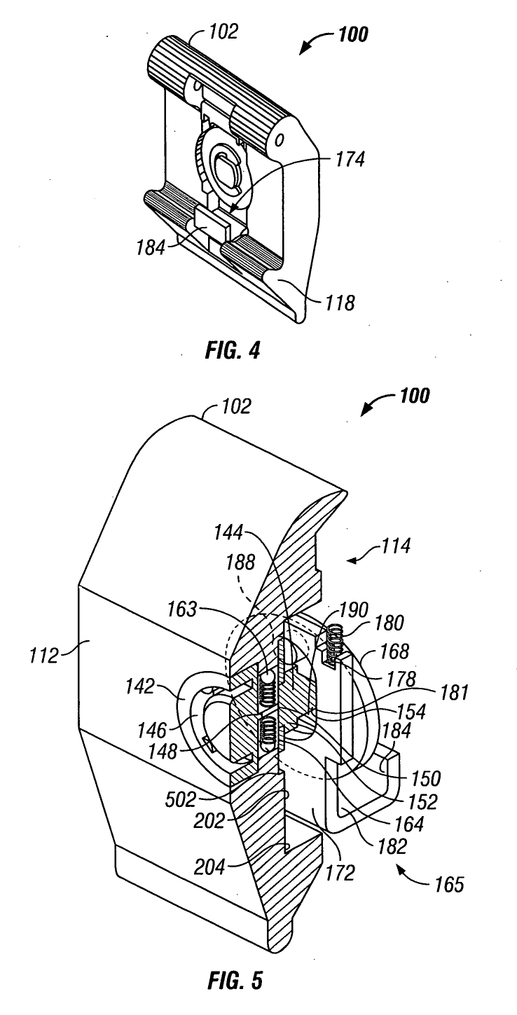

Further, the cam 188 is attached to the control plate 168 such that it extends away from the control plate contact surface 187 towards the space occupied by the follower member 172. When the hooking engagement mechanism 106 is assembled about neck 144, the cam 188 lies within the follower member aperture 176 of the follower member 172 such that the cam surface 192 is in contact with the follower aperture surface 181. The operational relation between the follower member assembly 165, the control plate 168 and the cam 188 is described in greater detail in relation to FIGS. 3 and 4 below.

The second C-shaped clamp 170 corresponds to, and when assembled is engaged with, the control plate securing groove 156 of neck 144 such that the hooking engagement mechanism 106 is securely attached to the neck 144 where the hooking engagement mechanism 106 is secured immediately adjacent to the casing 102 within a linear passageway therein. Consequently, the control plate 168 and the follower member assembly 165 are sandwiched between the second C-shaped clamp 170 and both the first C-shaped clamp 164 and the casing back 114.

Other embodiments use different hooking engagement mechanism 106 components. For example, another embodiment contains a control plate 168 that further contains a noncircular outer edge that works as a cam itself. Here, the follower member 165 has a follower member aperture 176 that receives the entire width of the control plate 168 and moves linearly as the control plate 168 is rotated. Here, an outer edge of the control plate acts as the cam surface 192.

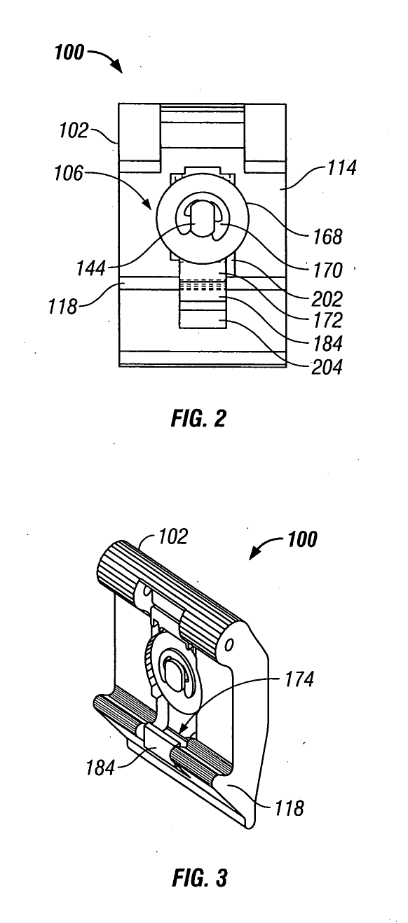

FIG. 2 shows a direct rear on view of the casing back 114 with the lock 100 in an unlocked position. As shown in FIG. 2, two recessed areas are located in casing 102 for receiving the hooking engagement mechanism 106. A first recessed area 202 generally extends from about the top portion of bottom ridge 118 upward to slightly above the top of control plate 168. The first recessed area 202 is generally for locating the free end of the neck 144, the first C-shaped clamp 164, the follower member 172, the control plate 168 and the second C-shaped clamp 170. A second recessed area 204 generally extends from about the top portion of bottom ridge 118 downward to near the bottom portion of casing 102. The second recessed area 204 is used for guiding the hook 174 in a linear direction.

FIG. 3 shows a back side perspective view of the lock 100 in its unlocked position. Here the top edge of the bottom ridge 118 is substantially aligned with the top edge of lip 184 of hook 174, thus allowing selective disengagement of a securing appendage of a bottom portion of a gun case (not shown) from lock 100.

FIG. 4 shows a back side perspective view of the lock 100 in its locked position. Here the top edge of the bottom ridge 118 is located substantially below the top edge of lip 184 of hook 174, thus preventing selective disengagement of a securing appendage of a bottom portion of a gun case (not shown) from lock 100.

FIG. 5 shows a perspective cutaway view of lock 100 in its locked position. Here, a subrecess 502, within recess 202, is visible between casing 102 and the follower member assembly 165. Located in this subrecess 502 is the first C-shaped clamp 164. The subrecess 502 has a depth substantially equal to the width of the first C-shaped clamp 164. Therefore, as the follower member 172 travels within the first recess area 202, it is in sliding contact with both the first C-shaped clamp and the back of the first recess area 202.

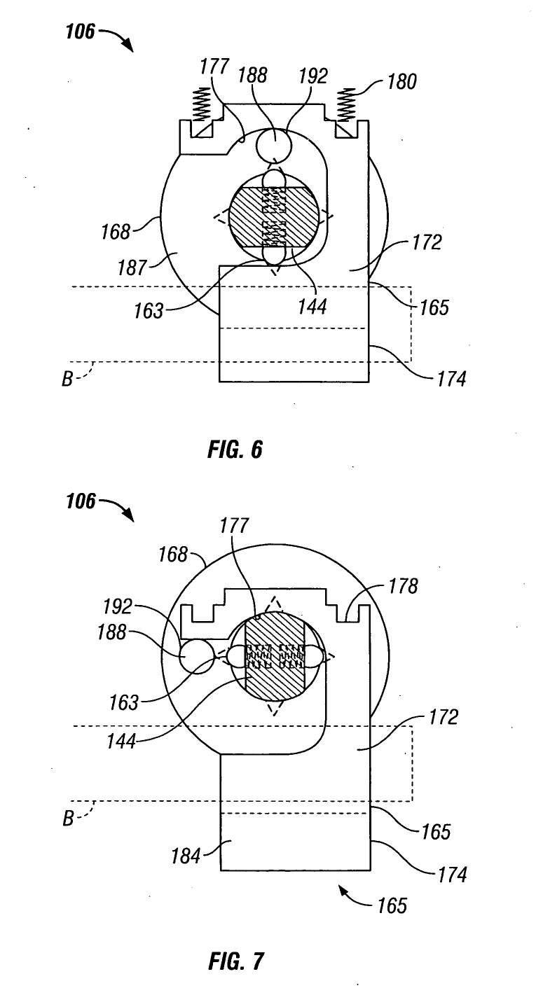

FIG. 6 shows a view of hooking engagement mechanism 106 in a locked or attached position with a securing appendage B. Here the securing appendage B represents a locking bar, lower lip, edge, aperture or other structure of a second object capable of mating with the hooking engagement mechanism 106. As shown, the securing appendage B is shown locked between the hook 174 and the follower member 172 of the follower member assembly 165. Another embodiment achieves a locking engagement between the hooking engagement mechanism 106 (see FIG. 1) and an aperture within a bottom object. Yet other embodiments use latches, hooks or other structures that are capable of achieving a locking connection with the hooking engagement mechanism 106 (see FIG. 1).

FIG. 7 shows a view of hooking engagement mechanism 106 in an unlocked or detached position with an external lip or securing appendage B. Here, the securing appendage B is located above the hook 174 of the follower member assembly 165. As so located, the securing appendage B is free to move away from the hooking engagement mechanism 106.

In operation, and in accordance with one embodiment, the lock 100 operates as follows. Lock 100 is attached to a gun case having top and bottom portions. The casing 102 is hingedly connected to the top of the gun case via a bolt passing through a first engagement portion aperture 124. Initially, the gun case is in a clamped shut position, but not in the locked position, with the bottom ridge 118 of casing 102 engaged with a lip (external securing appendage B) extending from the bottom of the gun case.

With the lock 100 in an unlocked status, the case is opened by pressing down on the top of the gun case, causing the top and bottom portions of the gun case to approach one another (i.e., by further collapsing a rubber sealing material located between such portions, or by repelling a force generated by other like or similar means that tend to cause a separating force between such top and bottom portions of the gun case), such that the bottom ridge 118 clears the lip on the bottom of the gun case. Here, the lock 100 can be pivoted about the first engagement portion aperture 124 such that the gun case may be opened to expose the contents therein. Another embodiment uses multiple locks 100 on the same gun case. In this case, the same operations associated with individual lock 100 would be further required for the additional locks.

With the lock 100 in an initial clamped and unlocked position, the lock 100 is in position to move from an unlocked state to a locked state such that the top and bottom portions of the gun case are locked together. FIGS. 2, 3 and 7 show the lock 100 in its unlocked state. To lock the lock 100, a key is inserted into the key port 146 in the control knob head 142. The key, along with the control knob head 142, is rotated in the clockwise direction to an angle of approximately 90 degrees. As a result, the lock assumes the relative positioning of the components of the lock 100 as reflected in FIGS. 4 and 6. The transition from the unlocked to the locked position is described as follows.

The neck 144 rotates 90 degrees in a clockwise direction such that its corresponding springs 162 and ball bearings 163 move from a position substantially horizontal to the width of the lock 100 to a corresponding vertical position. At the initial position, ball bearings 163 are in contact with one set of annular recessed areas 126, and at the rotated position the ball bearings 163 are in contact with another set of annular recessed areas 126. The flat portion of the control plate portion 154 of the neck 144 rotates from a position where the flat portion is substantially vertical to the width of the lock 100 to a correspondingly horizontal position.

The hooking engagement mechanism 106 transforms the 90 degrees of rotational motion of neck 144 into the linear movement of hook 174 from a position free of the lip on the bottom of the gun case to an engagement position where the lip is incapable of being freed from the hook 174 without the counterclockwise rotation of the neck 144. Here, the first bushing or C-shaped clamp 164 rotates 90 degrees in the clockwise direction where the casing side of the bushing 164 is in slideable rotational contact with the casing back 114. The follower member side of the bushing 164 is in slideable rotational contact with the follower member assembly 165.

Control plate 168, with the lock 100 in the initial unlocked position, maintains the control plate aperture 186 in a position corresponding to the position of the neck 144 in the same unlocked position. Here, the flat portions of control plate portions 154 of neck 144 are substantially vertical with respect to the width of lock 100. In the initial unlocked position, the cam 188 is positioned such that the cam 188 is at a nine o'clock location when viewed from a front perspective facing the lock 100. At the final locked position, the cam 188 is located at a 90 degrees offset in a twelve o'clock position. Between the unlocked and locked position, the cam surface 192 slides along the follower aperture surface 181 of the follower member 172 such that the contact point between the cam surface 192 and the follower aperture surface 181 changes by approximately 90° with respect to such contact point and the center of circular cam 188.

Follower member 172, in the initial unlocked position, is positioned with lip 184 below the lip on the bottom of the gun case. However, in the final locked position, the follower member 172 is positioned with lip 184 in engagement with the lip on the bottom of the gun case. In its initial unlocked position, the two springs 180 are decompressed within the pair of positioning recesses 178. Although decompressed, the springs 180 are not fully decompressed. The springs 180 retain at least enough force to keep the lip 184 positioned below the lip on the bottom of the gun case. When in the final locked position, the springs 180 are compressed, although ideally not fully compressed, such that any counterclockwise rotation of the neck 144 would cause movement of the cam and a corresponding downward movement of the follower member 172. As best shown in FIGS. 6 and 7, it should be noted that the follow member aperture 176 should be wide enough to allow the relative positioning of the neck 144 as the follower member 172 rises and falls in relation thereto.

Second bushing or C-shaped clamp 170 rotates 90 degrees in the clockwise direction in response to the corresponding rotation of neck 144. Because control plate 168 also follows the same rotational displacement, the second bushing 170 remains in static contact with both the neck 144 and the control plate 168. Although the above describes the transitioning of lock 100 from a locked to an unlocked state, the same description is also applicable to the transitioning from an unlocked to a locked state when viewed in reverse. That transitioning includes the counterclockwise movement of the control knob assembly 104 and the corresponding resulting movements of the affected lock 100 components.

### SECOND EMBODIMENT

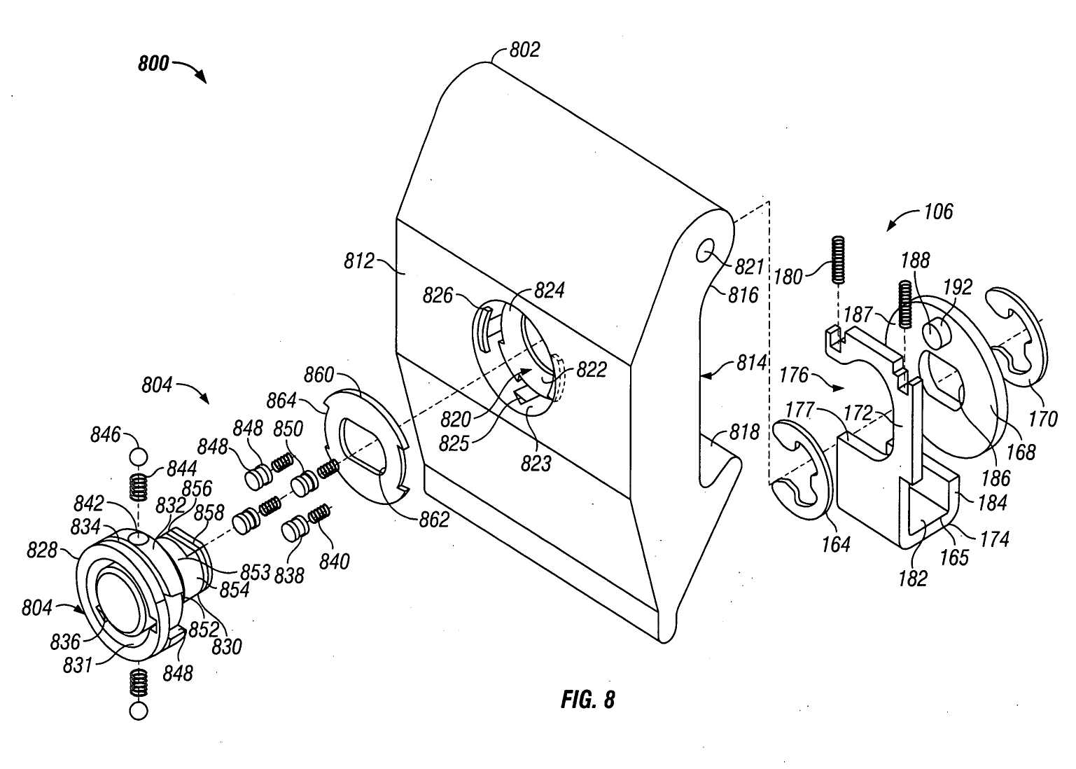

A second embodiment is shown in FIG. 8 and includes a lock 800 including a casing 802, a control knob assembly 804 and a hooking engagement mechanism 106. The casing 802 further contains a casing face 812, a casing back 814, a first engagement portion 816, a bottom ridge 818, a casing aperture 820 and a first engagement portion aperture 821.

The casing aperture 820 in casing 802 allows the control knob assembly 804 to be located therein. The casing aperture 820 further includes a casing aperture recess 822, an inner face 823, a casing bushing 824 and annular recessed areas 825. The inner face 823 defines the casing aperture 820 and is in contact with pre-tensioned ball bearings discussed below in relation to control knob assembly 804. The casing bushing 824 provides the attachment mechanism by which control knob assembly 804 and hooking engagement mechanism 106 are attached to casing 802. Here, the casing bushing 824 has extended portions about its circumference that engage with corresponding slits in the inner face 823 of casing aperture 820, thus securing the casing bushing 824 thereto. In other embodiments, the portion represented by the casing bushing 824 may be a contiguous portion of the casing 802 rather than a separate component. The annular recessed areas 825 are used to receive the pre-tensioned ball bearings therein. The casing aperture recess 822 receives a portion of the control knob assembly 804 therein. The inner face 823 also includes attached thereto a protruding bar 826 (protruding member) for use in locking and unlocking the lock 800.

The control knob assembly 804 includes a control knob head 828 and a neck 830. The control knob head 828 and neck 830 are integrally formed. Here, the control knob head 828 is hollow and the neck 830 extends into the hollow head. The control knob assembly 804 is used to operate or drive the hooking engagement mechanism 106 by the clockwise and counterclockwise turning of the assembly. The control knob head 828 contains a key port 831 for receiving a key to open lock 800. Further, control knob head 828 further includes a ball bearing section 832, a knob casing travel groove 834 and multiple receiving recesses 836 defined in its inner surface to receive therein locking pins 838 (moveable members) and locking pin springs 840. The ball bearing section 832 is an annular ring containing two opposing recesses 842, with corresponding springs 844 and ball bearings 846 (together, a ball-spring combination), and two control knob head cutouts 848 located on the outer surface thereof. When the control knob assembly 804 is secured within casing 802, the ball bearing section 832 is within the casing aperture 820 of casing 802 with protruding bar 826 located within knob casing travel groove 834. When the control knob assembly 804 is rotated, the two sets of corresponding springs 844 and ball bearings 846 engage the inside of the casing aperture 820 of casing 802.

As mentioned above, the inner surface of control knob head 828 contains multiple recesses 836. In these recesses are contained the locking pins 838. The locking pins 838 are cylindrical in nature and are defined by cylinder ends 849 having a larger diameter than the diameter of its cylinder center 850. Thus, when compared to outer or ends of the locking pins 838, the cylinder center 850 has a reduced diameter. The locking pins 838 are located on opposite sides of a protruding bar 826 such that there are generally two locking pins 838 for every protruding bar 826. In this embodiment, there are four locking pins 838. The locking pin springs 840 urge the locking pins towards the face of the control knob head 828. In so doing, the cylinder ends 849 of the locking pins 838 are located within knob casing travel groove 834, thereby reducing the depth of the travel groove 834 to a height less than protruding bar 826. As a result, any attempt to rotate the control knob head 828 without disengaging the cylinder ends 849 of the locking pins 838 from within the knob casing travel groove 834 (i.e., not engaging the cylinder center 850 with the knob casing travel groove 834) results in the cylinder ends 849 contacting the protruding bar 826 and preventing the rotation of the control knob head.

To properly align the cylinder center 850 of locking pins 838 with the protruding bar 826 a compatible and properly configured key is inserted into key port 831 wherein the key is allowed to travel down the key port 831 and contact the locking pins 834 such that they are displaced into alignment with the protruding bar 826. Now properly aligned, the control knob head 828 may be rotated wherein the protruding bar 826 falls within the two cylinder ends 849 of the locking pins 838. The key is designed such that peripheral edge has a pattern that engages the locking pins, via receiving recesses 836 within key port 831, to displace each locking pin 838 by the appropriate amount. Each of the locking pins is designed to have a different traveling distance (not shown) such that the correct key with the correct pattern is needed to displace each by the appropriate amount to be aligned with knob casing travel grove 834.

In this embodiment, only two protruding bars 826 are used, and these are in the form of partial length tongues protruding from the inner face 823 of a casing aperture 820. Others possessing ordinary skill in the art will recognize that other quantities or designs of locking pins 838 and protruding bars or the like may be used to achieve the same or similar functionality.

The neck 830 has a rotational axis about which it rotates. The neck 830 also has five portions: a knob casing securing groove 852, a follower member portion 853, a control plate portion 854, a control plate securing groove 856 and a backstop portion 858. The end of the neck having the backstop portion 858 is the free end of the neck 830. The follower member portion 853 is an annular ring having a diameter equal to the maximum diameter of neck 830. The control plate portion 854 is an annular ring having a general diameter equal to the maximum diameter of neck 830 and further containing a notched or flat portion on opposite sides of the neck 830. The control plate securing groove 856 is an annular groove having a smaller diameter than the maximum diameter of the neck 830. Finally, backstop portion 858 is an annular ring having a general diameter equal to the maximum diameter of neck 830 and further containing a notched portion therefrom on opposite sides of the neck 830 in a location corresponding to the notched portions of the control plate portion 854. Attached to neck 830 is a stopping plate 860 having a center cutout portion 862 with a diameter equal to the maximum diameter of neck 830 and stopping plate cutout portions 864 located on the outer side face of the stopping plate and sized to pass over protruding bar 826. The stopping plate cutout portions 864 correspond in shape and depth to the control knob head cutouts 848 in the control knob head 828. The stopping plate 860 is attached to neck 830 such that locking pin springs 840 and locking pins 838 are secured in the receiving recesses 836 such that the distal ends of the locking pin springs 840 are in contact with the stopping plate 860. Thus, the location of the stopping plate 860 prevents the locking pins 838 and the locking pin springs 840 from escaping from the receiving recesses 836.

The hooking engagement mechanism 106 is the same as or similar to that described with regard to the first embodiment. Here, the second C-shaped clamp 170 engages with the control plate securing groove 856 of the second embodiment rather than control plate securing groove 156 of the first embodiment. In addition, the first C-shaped clamp 164 engages knob casing securing groove 852 of the second embodiment rather than knob casing securing groove 150 of the first embodiment. Also, the follower member 172 is located above the follower member portion 853 of neck 830, and the control plate 168 is located above the control plate portion 854 of the neck 830.

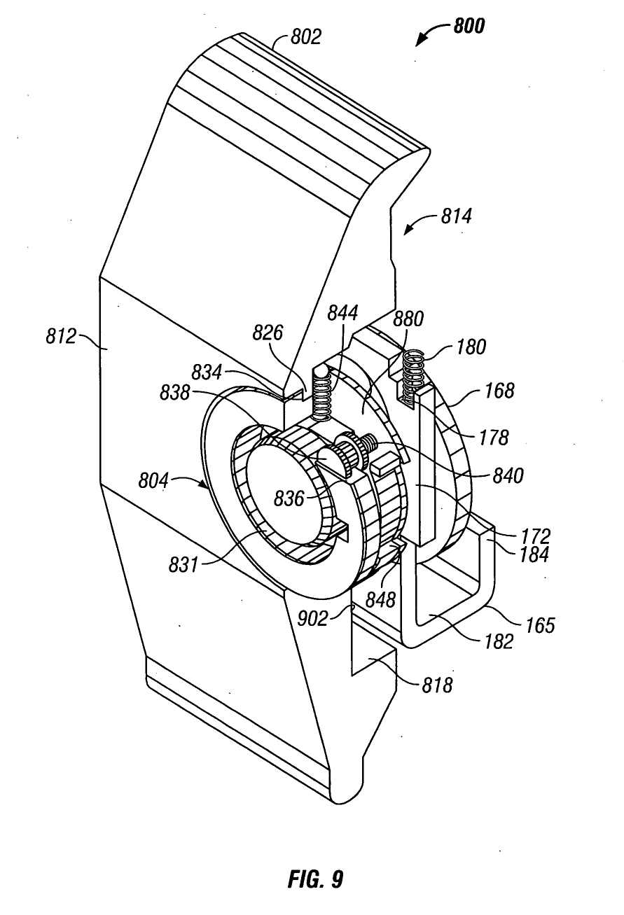

FIG. 9 shows a perspective cutaway view of lock 800 in its locked position. Here, a recess area 902 is visible between the casing 802 and the follower member assembly 165. Therefore, as the follower member 172 travels within the recess area 902, it is in sliding contact with the back of the first recess area 902. Also, the springs 180 are shown in a compressed position, with the follower lip 184 located substantially above the bottom ridge 818.

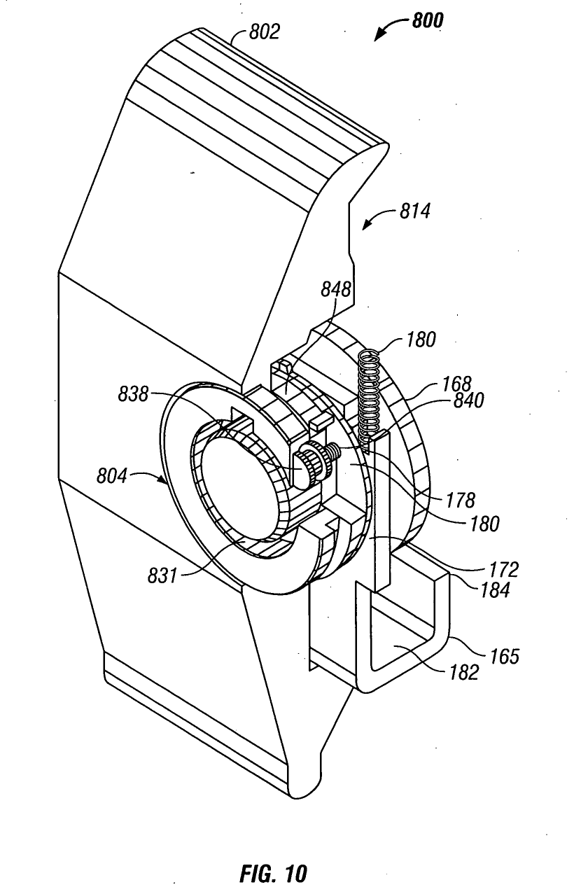

FIG. 10 shows a perspective cutaway view of lock 800 in its unlocked position. Here, the springs 180 are shown in an extended position with the follower lip 184 located near the bottom ridge 818 shown in the drawing (see FIG. 9).

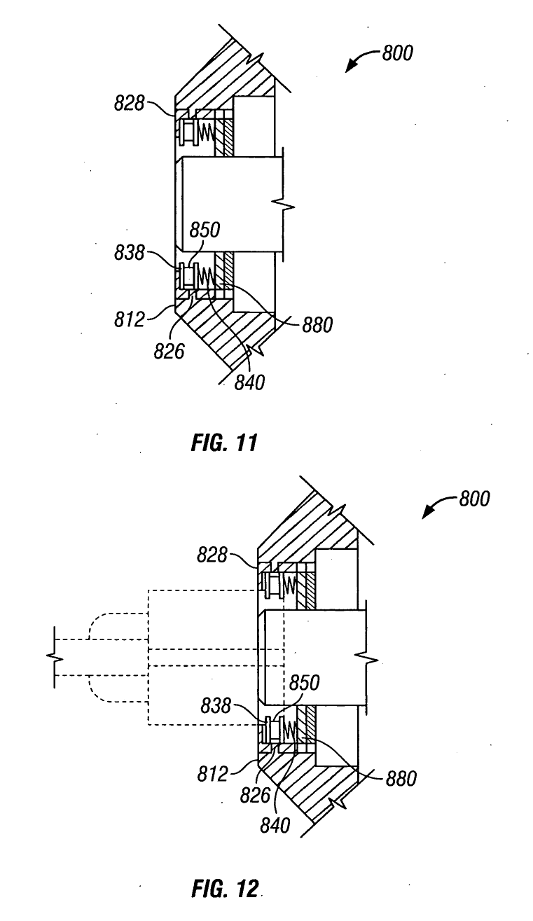

FIG. 11 shows a side cutaway view of a portion of lock 800 in a locked position. Here, the locking pins 838 are shown out of alignment or misaligned with protruding bars 826. Consequently, the cylinder center 850 is not lined up with the protruding bars 826, and the control knob head 828 cannot rotate and is otherwise immovable.

FIG. 12 shows a side cutaway view of a portion of lock 800 in an operating position. Here, the locking pins 838 are shown in alignment with protruding bars 826. As a result, the cylinder center 850 is lined up with the protruding bars 826, and the control knob head 828 can be rotated to open or close the lock. Further, the alignment is shown being achieved via the insertion of a key (shown in phantom) where the teeth (not shown) of the key have engaged the locking pins 838 and compressed the corresponding locking pin springs 840.

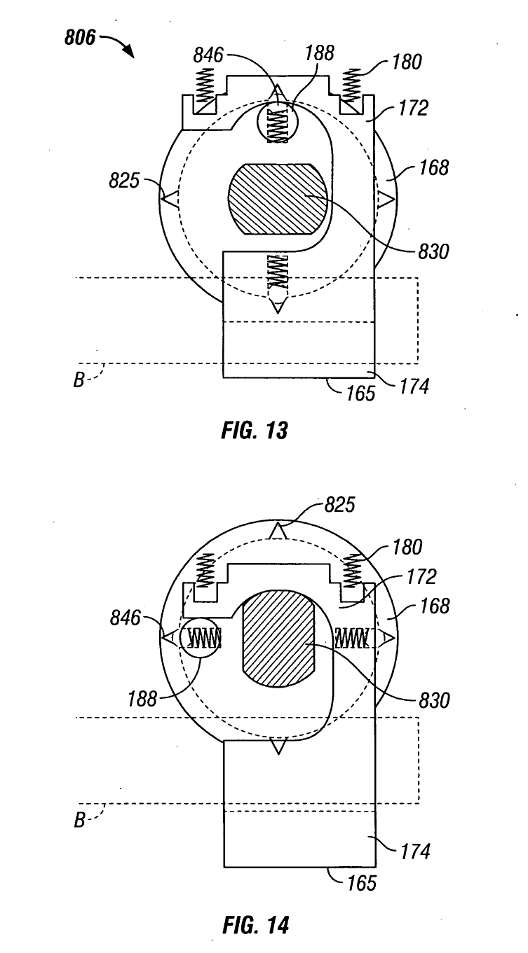

FIG. 13 shows a view of hooking engagement mechanism 106 (see FIG. 8) in a locked or attached position with a securing appendage B. As shown, the securing appendage B is shown locked between the hook 174 and the follower member 172 of the follower member assembly 165 (see FIG. 8).

FIG. 14 shows a view of hooking engagement mechanism 106 (see FIG. 8) in an unlocked or detached position with an external lip or securing appendage B. Here, the securing appendage B is located above the hook 174 of the follower member assembly 165 (see FIG. 8). As so located, the securing appendage B is free to move away from the hooking engagement mechanism 106 (see FIG. 8).

In operation, in this embodiment, to engage the lock 800, a key is inserted into the key port 831 in the control knob head 828. The key then meshes with the locking pins 838 extending into the key port 831 via receiving recesses 836, causing the locking pins 838 to move while compressing the associated locking pin springs 840. The locking pins 838 move backward until their cylinder centers 850 are lined up with protruding bars 826. Once lined up, the key, along with the control knob head 828, is rotated in the clockwise direction to an angle of approximately 90 degrees. As a result, the lock assumes the relative positioning of the components of the lock 800 as reflected in FIGS. 9 and 13. The transition from the unlocked to the locked position is described as follows.

The neck 144 rotates 90 degrees in the clockwise direction such that its corresponding springs 844 and ball bearings 846 move from a position substantially horizontal to the width of the lock 800 to a corresponding vertical position. At the initial position, ball bearings 846 are in contact with one set of annular recessed areas 825, and at the rotated position the ball bearings 846 are in contact with another set of annular recessed areas 825. The flat portion of the control plate portion 854 of the neck 830 rotates from a position where such flat portion is substantially vertical to the width of the lock 800, to a correspondingly horizontal position. As a result, the hooking engagement mechanism 106 functions as described above with regard to the first embodiment.

While only a few embodiments and aspects of the invention have been described above, including the preferred embodiment, those of ordinary skill in the art will recognize that these embodiments and aspects may be modified and altered without departing from the central spirit and scope of the invention. Thus, the embodiments and aspects described above are to be considered in all respects as illustrative and not restrictive, the scope of the invention being indicated by the appended claims rather than by the foregoing description, and all changes that come within the meaning and range of equivalency of the claims are intended to be embraced herein.

1. A lock comprising:
a casing adapted to firmly engage a first object with a second object;
a control knob assembly having a neck extending through the casing and rotatably received in the casing; and
a hooking engagement mechanism securely mounted on the control knob assembly to secure the control knob assembly to the casing, the hooking engagement mechanism having a follower member with a follower member aperture defined to receive therein the neck and a hook perpendicularly extending therefrom and a control plate firmly connected to the neck of the control knob assembly and having a cam formed to abut an inner face defining the follower member aperture of the follower member so that rotatable movement of the control knob assembly is able to drive the follower member to move linearly to complete an attachment and detachment with a securing appendage on the second object.

2. The lock as claimed in claim 1, wherein the control knob assembly has a control knob head that is integrally formed with the neck and two recesses defined in opposite sides of the neck to respectively receive therein a ball-spring combination, and the casing has one or more annular recessed areas defined in an inner face defining a casing aperture to correspond to the ball-spring combination such that, when the control knob assembly is rotated in the casing aperture of the casing, the control knob assembly is able to be positioned due to the relationship between the ball-spring combination and the annular recessed areas in the casing.

3. The lock as claimed in claim 1, wherein the hooking engagement mechanism further has a casing bushing and a second C-shaped clamp, the neck has a first annular groove corresponding to the casing bushing and a second annular groove corresponding to the second C-shaped clamp so that the neck is able to be secured by the casing bushing and the second C-shaped clamp, and the follower member and the control plate are securely sandwiched between the casing bushing and the second C-shaped clamp.

4. The lock as claimed in claim 2, wherein the hooking engagement mechanism further has a casing bushing and a second C-shaped clamp, the neck has a first annular groove corresponding to the casing bushing and a second annular groove corresponding to the second C-shaped clamp so that the neck is able to be secured by the casing bushing and the second C-shaped clamp, and the follower member and the control plate are securely sandwiched between the casing bushing and the second C-shaped clamp.

5. The lock as claimed in claim 4, wherein the neck further has a flat portion formed on a free end of the neck and the control plate has a control plate aperture to correspond to the neck, the control plate aperture being so defined that, after the neck is received in the control plate aperture, the neck is immovable relative to the control plate.

6. The lock as claimed in claim 1, wherein the follower member has at least a positioning recess defined in a top face of the follower member to receive therein a spring such that, when the follower member is attached to the securing appendage, the spring is compressed, and, when the follower member is detached to the securing appendage, the spring is decompressed.

7. The lock as claimed in claim 2, where the follower member has at least a positioning recess defined in a top face of the follower member to receive therein a spring such that, when the follower member is attached to the securing appendage, the spring is compressed, and, when the follower member is detached to the securing appendage, the spring is decompressed.

8. The lock as claimed in claim 3, wherein the follower member has at least a positioning recess defined in a top face of the follower member to receive therein a spring such that, when the follower member is attached to the securing appendage, the spring is compressed, and, when the follower member is detached to the securing appendage, the spring is decompressed.

9. The lock as claimed in claim 4, where the follower member has at least a positioning recess defined in a top face of the follower member to receive therein a spring such that, when the follower member is attached to the securing appendage, the spring is compressed, and, when the follower member is detached to the securing appendage, the spring is decompressed.

10. The lock as claimed in claim 5, where the follower member has at least a positioning recess defined in a top face of the follower member to receive therein a spring such that, when the follower member is attached to the securing appendage, the spring is compressed, and, when the follower member is detached to the securing appendage, the spring is decompressed.

11. A lock comprising:
a control knob with a hollow head and a neck integrally formed with and extending into the hollow head, wherein one or more receiving recesses are defined in an inner surface of the hollow head to receive therein locking pins and locking pin springs, and two control knob head cutouts are respectively defined in an outer side face of the hollow head, each locking pin having a reduced diameter portion formed in a center of the locking pin;
a stopping plate engaging with distal ends of the locking pin springs to prevent the locking pins and the springs from escaping from the receiving recesses, the stopping plate provided with two stopping plate cutouts respectively defined in an outer side face of the stopping plate to correspond to the two control knob head cutouts in the hollow head; and
a casing with an aperture to rotatably receive therein the neck of the control knob and having at least two protruding bars to selectively align with the reduced diameter portions of the locking pins such that, when the reduced diameter portions of the locking pins are not in alignment with the protruding bars, the control knob is not rotatable relative to the casing, and, when the reduce diameter portions of the locking pins are in alignment with the protruding bars, the control knob is rotatable in relation to the casing.

12. A lock comprising:
A casing adapted to firmly engage with an object and having protruding bars formed on an inner surface defining a casing aperture in the casing;
a control knob attached to a neck, the neck extending through the casing and rotatably received in the casing, one or more receiving recesses defining in the control knob to movably receive therein a locking pin and a locking pin spring and a stopping plate engaging with distal ends of the locking pin spring to prevent the locking pin and the locking pin spring from escaping from the receiving recesses, the locking pin having a reduced diameter portion to selectively align with the protruding bars such that the control knob is rotatable with respect to the casing when the reduced diameter portions of the locking pin are in alignment with the protruding bars, and, when the reduced diameter portions of the locking pin is in misalignment with the protruding bars, the control knob is immovable in relation to the casing; and
a hooking engagement mechanism securely mounted on the neck to secure the neck to the casing, the hooking engagement mechanism having a follower member assembly with a follower member aperture defined to receive therein the neck and a hook perpendicularly extending therefrom and a control plate firmly connected to the neck and having a boss formed to abut the follower aperture surface defining the follower member aperture of the follower member assembly so that rotatable movement of the control knob is able to drive the follower member assembly to move linearly to complete an attachment and detachment with a locking bar.

13. The lock as claimed in claim 12, wherein the control knob has a control knob head which is integrally formed with the neck and two recesses defined in opposite sides of the neck to respectively receive therein a ball-spring combination, the casing has multiple annular recessed areas defined in an inner face defining the casing aperture to correspond to the ball-spring combination such that, when the control knob is rotated in the casing aperture of the casing, the control knob is able to be positioned in a specific predefined orientation due to the relationship between the ball-spring combination and the annular recessed areas in the casing.

14. The lock as claimed in claim 12, wherein the hooking engagement mechanism further has a first C-shaped clamp and a second C-shaped clamp, the neck has a knob casing securing groove corresponding to the first C-shaped clamp and a control plate securing groove corresponding to the second C-shaped clamp so that the neck is able to be secured by the first and second C-shaped clamp and the follower member assembly, and the control plate are securely sandwiched between the first C-shaped clamp and the second C-shaped clamp.

15. The lock as claimed in claim 13, wherein the hooking engagement mechanism further has a first C-shaped clamp and a second C-shaped clamp, the neck has a knob casing securing groove corresponding to the first C-shaped clamp and a control plate securing groove corresponding to the second C-shaped clamp so that the neck is able to be secured by the first and second C-shaped clamp, and the follower member assembly and the control plate are securely sandwiched between the first C-shaped clamp and the second C-shaped clamp.

16. The lock as claimed in claim 15, wherein the neck further has control plate flat portions formed on a free end of the neck and the control plate has a control plate aperture to correspond to control plate flat portions on the neck, the control plate aperture being so defined that, after the neck is received in the control plate aperture, the neck is immovable relative to the control plate.

17. The lock as claimed in claim 12, wherein the follower member assembly has at least a positioning recess defined in a top face of the follower member assembly to receive therein a spring such that, when the follower member assembly is attached to the locking bar, the spring is compressed, and, when the follower member assembly is detached from the locking bar, the spring is decompressed.

18. The lock as claimed in claim 13, wherein the follower member assembly has at least a positioning recess defined in a top face of the follower member assembly to receive therein a spring such that, when the follower member assembly is attached to the locking bar, the spring is compressed, and, when the follower member assembly is detached from the locking bar, the spring is decompressed.

19. The lock as claimed in claim 14, wherein the follower member assembly has at least a positioning recess defined in a top face of the follower member assembly to receive therein a spring such that, when the follower member assembly is attached to the locking bar, the spring is compressed, and, when the follower member assembly is detached from the locking bar, the spring is decompressed.

20. The lock as claimed in claim 15, wherein the follower member assembly has at least a positioning recess defined in a top face of the follower member assembly to receive therein a spring such that, when the follower member assembly is attached to the locking bar, the spring is compressed, and, when the follower member assembly is detached from the locking bar, the spring is decompressed.

21. A lock for securing a first object to a second object comprising:
a casing having a casing back and a first engagement portion for attaching the casing to the first object;
a control knob assembly rotatably connected to the casing; and
a hooking engagement mechanism operably connected to the control knob assembly and responsive to rotation of the control knob assembly and further including:
a cam operably connected to the control knob assembly and having a cam surface and a cam rotational axis, wherein the cam surface is noncircular with respect to the cam rotational axis such that rotation of the cam about the cam rotational axis results in the oscillation of the cam surface with respect to a fixed radius from the cam rotational axis;
a follower member having a follower member aperture for engaging the cam surface, wherein the oscillating of the cam surface causes the follower member to move linearly with respect to the cam rotational axis; and
a second engagement portion fixedly attached to the follower member, wherein the linear movement of the follower member causes the second engagement portion to move linearly to engage and disengage a securing appendage of a second object.

22. The lock of claim 21 wherein the follower member aperture includes a follower aperture surface, and wherein the cam surface is in moveable contact with the follower aperture surface such that the rotational movement of the cam causes the follower member to move linearly.

23. The lock of claim 21 wherein the movement of the follower member is restricted to moving in a linear path defined by a linear passageway in the casing.

24. The lock of claim 21 further comprising springs which urge the movement of the follower member in a linear path.

25. The lock of claim 21 further comprising a control plate having a control plate contact surface, wherein the control plate is operably connected to the control knob assembly and wherein the cam is fixedly connected to the control plate and protrudes from the control plate contact surface.

26. The lock of claim 25 wherein the control knob assembly further comprises a control knob head and a neck wherein the control knob and the control plate are fixedly connected to the neck.

27. The lock of claim 26 further comprising a bushing fixedly connected to the neck to secure the control plate and the follower member between the bushing and the casing back such that the cam surface is maintained within the follower member aperture.

28. The lock of claim 27 wherein the neck further contains an annular groove and wherein the bushing is a C-shaped clamp and wherein the C-shaped clamp is fixedly connected to the neck within the annular groove.

29. A lock for securing a first object to a second object comprising:
a casing having casing back and first engagement portion wherein the first engagement portion is hingedly attached to the first object;
a control knob assembly rotatably connected to the casing and further including:
a control knob head for rotating the control knob assembly; and
a neck fixedly attached to the control knob head and having a neck rotational axis; and
a hooking engagement mechanism rotatably attached to the neck and further including:
a control plate having a control plate contact surface, wherein the control plate is fixedly attached to the neck;
a cam extending from the surface of the control plate contact surface, the cam having a cam surface and a cam rotational axis, wherein the cam surface is noncircular with respect to the cam rotational axis such that rotation of the cam about the cam rotational axis results in the oscillation of the cam surface with respect to a fixed radius from the cam rotational axis;
a follower member having a follower member aperture and a follower aperture surface, wherein the cam surface is in moveable contact with the follower aperture surface such that the rotational movement of the cam causes the follower member to move linearly with respect to the cam rotational axis;
a bushing fixedly connected to the neck such that the control plate and the follower member are maintained between the bushing and the casing back such that the cam surface is located within the follower member aperture; and
a second engagement portion fixedly attached to the follower member, wherein the linear movement of the follower member causes the second engagement portion to move linearly to engage and disengage a second object.

30. A lock for securing a first object to a second object comprising:
a casing having a casing aperture defined by a cylindrical inner face and having a protruding member extending from the cylindrical inner face into the casing aperture to a protruding member location; and
a control knob assembly located within the casing aperture and rotatably connected to the casing and further comprising at least two moveable members moveably attached thereto and capable of moving such that, in one position, the moveable members are located on either side of the protruding member and the control knob assembly is immoveable in a rotatable direction, and, in another position, the moveable members are located relative to the protruding member and the control knob is moveable in a rotatable direction.

31. The lock of claim 30 wherein the moveable members are locking pins having a reduced diameter portion to selectively align with the protruding members such that the control knob is rotatable with respect to the casing when the reduced diameter portions of the locking pins are in alignment with the protruding members, and, when the reduced diameter portions of the locking pins are in misalignment with the protruding members, the control knob is immovable in relation to the casing.

32. The lock of claim 31 wherein moveable members are displaced by a properly configured key inserted into a key port in the control knob.

33. The lock of claim 31 wherein the control knob further comprises a front and wherein the locking pins are biased towards the front of the control knob by locking pin springs.

34. The lock of claim 33 wherein the distal ends of the locking pin springs are in contact with a stopping plate.

35. The lock of claim 34 wherein the control knob is connected to a neck and the neck is connected to the stopping plate.
